(19) United States
(12) Patent Application Publication
(10) Pub. No.: US 2004/0129579 A1
(43) Pub. Date: Jul. 8, 2004

(54) Photonic signal reporting of electrochemical events

(76) Inventors: Richard M. Crooks, College Station, TX (US); Li Sun, College Station, TX (US); David Albagli, College Station, TX (US)

Correspondence Address: BAKER BOTTS L.L.P., 2001 ROSS AVENUE, SUITE 600, DALLAS, TX, 75201-2980, US

(21) Appl. No.: 10/625,791

(22) Filed: Jul. 22, 2003

Related U.S. Application Data
(63) Continuation-in-part of application No. 10/393,942, filed on Mar. 21, 2003.
(60) Provisional application No. 60/398,198, filed on Jul. 23, 2002.

(51) Int. Cl. G01N 27/26

(52) U.S. Cl. 205/775; 204/400

(57) ABSTRACT

According to one embodiment of the invention, a method for detecting the presence or amount of an analyte includes associating a first electrolyte solution containing the analyte with a first region of a bipolar electrode, associating a second electrolyte solution containing an electrochemiluminescent system with a second region of the bipolar electrode, ionically isolating the first electrolyte solution from the second electrolyte solution, causing a potential difference between the first and second electrolyte solutions, and detecting light emitted from the electrochemiluminescent system, thereby indicating the presence or amount of the analyte at the first region of the bipolar electrode.

### RELATED APPLICATIONS

This application claims the benefit of serial No. 60/398,198, entitled “Electrochemical Sensing in Microfluidic Systems using Electrogenerated Chemiluminescence as a Photonic Reporter of Electroactive Species,” filed provisionally on Jul. 23, 2002.

This application is also a continuation-in-part of U.S. application Ser. No. 10/393,942, filed Mar. 21, 2003, entitled “ELECTROCHEMICAL SENSING IN MICROFLUIDIC SYSTEMS USING ELECTROGENERATED CHEMILUMINESCENCE AS A PHOTONIC REPORTER OF ELECTROACTIVE SPECIES,” now pending, which claims the benefit of serial No. 60/398,198 described above.

### GOVERNMENT RIGHTS

This invention was made with Government support from the Army Medical Research & Material Command, Contract No. DAMD17-00-2-0010. The government may have certain rights in this invention.

### TECHNICAL FIELD OF THE INVENTION

This invention relates generally to the field of electrochemistry and more particularly to photonic signal reporting of electrochemical events.

### BACKGROUND OF THE INVENTION

A redox molecule is a molecule that can be reduced or oxidized by an electrode when a suitable potential bias is applied. The reduction or oxidation of the redox molecule is referred to as a redox reaction. Redox reactions occur in many applications, such as batteries, fuel cells, medical diagnostics, and film production, to name a few. Redox molecules may serve many useful purposes. For example, redox molecules may be used as labels, in which a redox molecule is attached to an analyte of interest and detection of the redox molecule via a redox reaction indicates the presence of the analyte to which it is attached. In some cases an analyte of interest may be intrinsically redox-active. This labeling approach, or the intrinsic property, is used in the medical diagnostic industry, among others, to detect DNA, proteins, antibodies, antigens, and other substances, via electrochemical detection.

In a conventional electrochemical sensor of the type sometimes used in chromatographic detectors, the potential of a working electrode is controlled with respect to that of a reference electrode, and the Faradaic current flowing between the working electrode and an inert counter electrode is measured. In this type of approach, the entire information content of the system is provided by the reaction at the working electrode.

In another approach to electrochemical detection, an electrode is used to trigger a redox reaction that results in the emission of light by electrochemiluminescence (ECL). Aurora and Manz, in PCT Application WO 00/0323, report on an apparatus containing floating reaction electrodes that may be used as an electrochemiluminescence cell. Massey et al. in U.S. Pat. No. 6,316,607 disclose traditional ECL labels and schemes for the detection of such labels, but the utility of the method again relies upon one electrode providing the entire information content. De Rooij et al. in U.S. Pat. No. 6,509,195 disclose an electrochemiluminescent detector for analyzing a biologicial substance in which the method also employs labels that serve as both marker and ECL emitter.

The ECL-based methods of detection are an improvement over conventional amperometric or potentiometric electrochemical detection methods in that they are generally more sensitive. The better sensitivity is due to the availability of ultrasensitive photon detectors and the elimination of some of the noise present in the redox signal by the conversion to a light signal. Means for improvement of the current practices is inherently limited by the methods practiced. For example, the redox label and ECL emitter are generally one in the same and therefore each process, redox sensing and light emission, cannot be independently optimized.

### SUMMARY OF THE INVENTION

According to one embodiment of the invention, a method for detecting the presence or amount of an analyte includes associating a first electrolyte solution containing the analyte with a first region of a bipolar electrode, associating a second electrolyte solution containing an electrochemiluminescent system with a second region of the bipolar electrode, ionically isolating the first electrolyte solution from the second electrolyte solution, causing a potential difference between the first and second electrolyte solutions, and detecting light emitted from the electrochemiluminescent system, thereby indicating the presence or amount of the analyte at the first region of the bipolar electrode.

According to another embodiment of the invention, a method for detecting the presence or amount of multiple analytes includes associating a first electrolyte solution containing the multiple analytes with first regions of a plurality of bipolar electrodes each with an analyte-specific binding reagent associated therewith, associating a second electrolyte solution containing an electrochemiluminescent system with the second regions of the bipolar electrodes, ionically isolating the first and second electrolyte solutions, causing a potential difference between the first and second electrolyte solutions, and detecting light emitted from the electrochemiluminescent systems associated with the respective second regions of the bipolar electrodes, thereby indicating the presence or amount of each of the multiple analytes at the respective first regions of the bipolar electrodes.

According to another embodiment of the invention, a method for detecting the presence or amount of an analyte includes associating a first electrolyte solution containing the analyte with a first container comprising a first electrode and a second electrode, associating a light emitting source with a second container comprising a third electrode and a fourth electrode, electronically coupling the first and third electrodes, causing a potential difference between the second and fourth electrodes, and detecting light emitted from the light emitting source in the second container, thereby indicating the presence or amount of the analyte in the first container.

According to another embodiment of the invention, a method for detecting the presence or amount of multiple analytes includes associating a first electrolyte solution containing the multiple analytes with a first container comprising a plurality of first electrodes each with an analyte-specific binding reagent associated therewith and a second electrode, associating a plurality of light emitting source with a second container comprising a plurality of third electrodes and a fourth electrode, electronically coupling the plurality of first and third electrodes, causing a potential difference between the second and fourth electrodes, and detecting light emitted by the plurality of light emitting sources associated with the respective plurality of third electrodes, thereby indicating the presence or amount of each of the multiple analytes in the first container.

Embodiments of the invention provide a number of technical advantages. Embodiments of the invention may include all, some, or none of these advantages. According to one embodiment of the invention, a method for detecting electrochemical events and reporting them photonically is provided. Because the anode and cathode processes are chemically decoupled, it is not necessary for the target analyte to participate directly in the ECL reaction sequence. This greatly increases the number of analytes that are detectable using the highly sensitive ECL process. The anode and cathode reactions are coupled electronically and, therefore, it is possible to correlate ECL intensity to the concentration of the analyte, thereby quantifying it.

According to another embodiment of the invention, it is shown that by changing the shape of the anode and cathode relative to one another, it is possible to lower the limit of detection.

In addition to decoupling the chemistry of the sensing and reporting functions of this sensor, the ability of the system to operate with bipolar electrodes, which have no external electrical contacts, is advantageous in some embodiments of the invention. A plurality of such bipolar electrodes may be arrayed within a device and all made active by the same electric field. This strategy simplifies the system design for multiplexed analyses such as for the simultaneous analysis of 5, 50 or even 50,000 different analytes. According to another embodiment, by using bipolar electrodes of differing length, it is possible to create electrode arrays to detect targets whose half reactions have different formal potentials. It is shown that such a device could operate by either measuring the intensity of the ECL or the length of the electrode that is illuminated.

In any of the embodiments of the subject invention, such a device could be miniaturized with a small battery providing the necessary potential bias between the electrodes and a photodiode measuring the light emitted by the ECL system.

Other technical advantages may be ascertained by one skilled in the art.

### BRIEF DESCRIPTION OF THE DRAWINGS

Reference is now made to the following description taken in conjunction with the accompanying drawings, wherein like reference numbers represent like parts, in which:

FIG. 1A is a schematic elevation view of a system for detecting the presence of an analyte according to one embodiment of the present invention;

FIG. 1B is a schematic plan view illustrating an embodiment of the system of FIG. 1A;

FIG. 1C is a schematic plan view of a system for detecting the presence of an analyte in which bipolar electrodes of varying length are utilized;

FIG. 1D is a schematic plan view of a system for detecting the presence of an analyte in which an array of bipolar electrodes is utilized;

FIG. 2 is a schematic plan view illustrating an embodiment of a system for detecting the presence of an analyte according to one embodiment of the invention in which two separate electrodes are utilized;

FIG. 3 is a schematic plan view illustrating an embodiment of a system for indirectly detecting the presence of an analyte according to one embodiment of the invention in which three electrode regions are utilized;

FIG. 4 is a flowchart illustrating a method for detecting the presence of an analyte according to one embodiment of the present invention;

FIG. 5A is a schematic diagram of a system for detecting the presence of an analyte according to an embodiment of the invention in which isolated sample and signal compartments are utilized;

FIG. 5B is a schematic diagram of an embodiment of the system of FIG. 5A in which a plurality of bipolar electrodes span between the compartments;

FIG. 6 is a schematic diagram of an embodiment of the system of FIG. 5A in which redox recycling of the analyte is utilized;

FIG. 7 is a schematic diagram of an embodiment of the system of FIG. 5A in which an annihilation reaction producing an ECL signal is utilized;

FIG. 8 is a schematic diagram of an embodiment of the system of FIG. 5A in which a light-emitting diode produces the photonic signal;

FIG. 9 is a cross-sectional view of an embodiment of a system for detecting the presence of an analyte in which the system includes a sample and a signal compartment with a bipolar electrode spanning between them;

FIG. 10 is a cross-sectional view of an embodiment of the system of FIG. 9 in which a plurality of bipolar electrodes spans between the sample and signal compartments;

FIG. 11 is a cross-sectional view of an embodiment of a system for detecting the presence of an analyte in which the system includes an array of separate sample compartments and a common signal compartment;

FIG. 12 is a schematic diagram of an embodiment of a system for detecting the presence of an analyte in which the system includes a series of separate sample compartments and a common signal compartment;

FIG. 13A is a cyclic voltammogram of 0.1 M phosphate buffer [pH 6.9] containing 5 mM Ru(bpy)₃Cl₂ and 25 mM tripropylamine (curve a) and the same solution with 1 mM benzyl viologen dichloride (curve b);

FIG. 13B is a graph of the normalized ECL intensity at 610 nm for the two solutions of FIG. 13A, as a function of applied potential bias in a two-electrode cell;

FIG. 14 is a graph of the ECL emission intensity as a function of the relative area of anodic and cathodic regions of a bipolar electrode according to an embodiment of the invention;

FIG. 15A is a graph of the current versus applied potential offset and FIG. 15B is a graph of the light intensity versus applied potential offset obtained utilizing an embodiment of the system illustrated in FIG. 5A; and

FIG. 16A is a graph of the current versus applied potential and FIG. 15B is a graph of the light intensity versus applied potential obtained utilizing an embodiment of the system illustrated in FIG. 8.

### DETAILED DESCRIPTION OF EXAMPLE EMBODIMENTS OF THE INVENTION

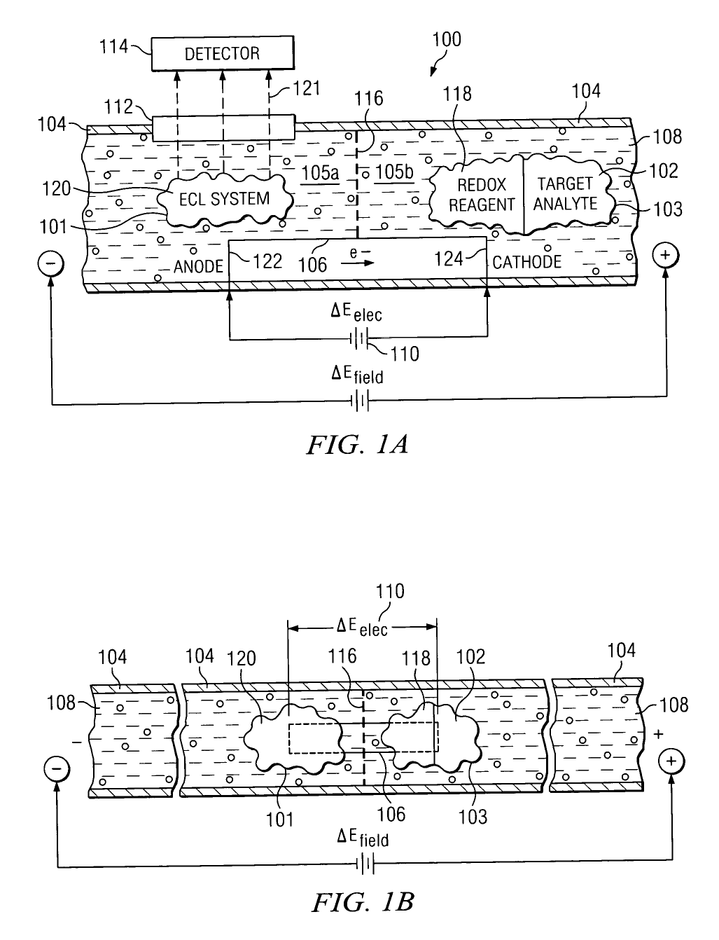

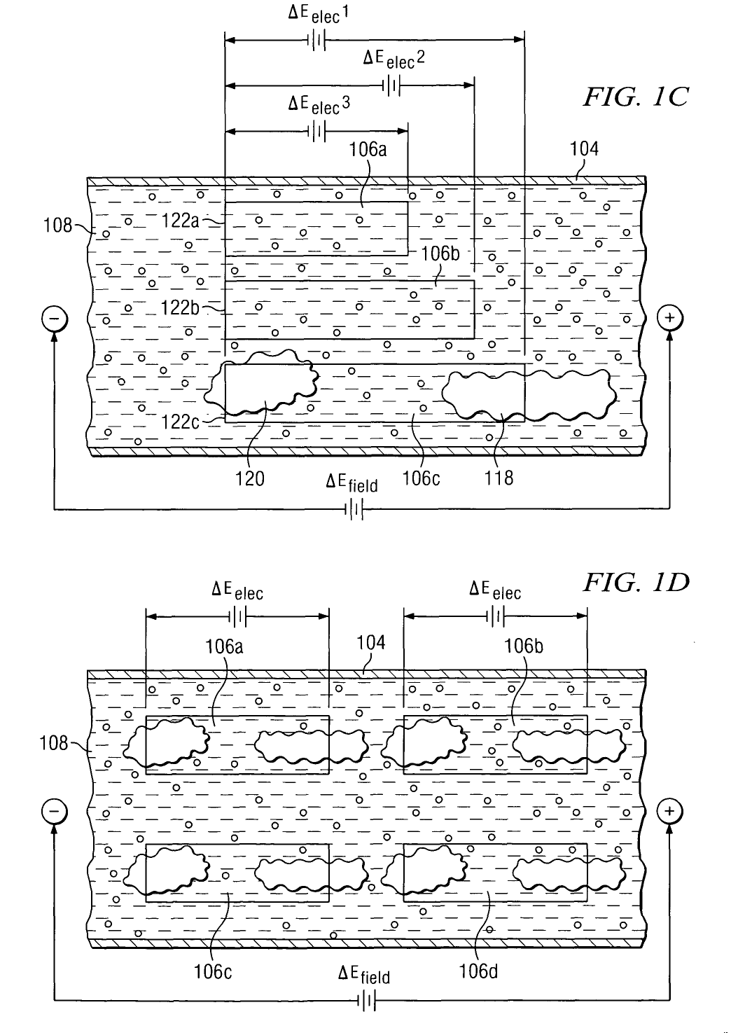

FIG. 1 is a schematic elevation view of a microfluidics-based sensing system 100 that relies on electrochemical detection and electrogenerated chemiluminescent (“ECL”) reporting in accordance with one embodiment of the present invention. Generally, system 100 is utilized to detect the presence of a target analyte 102 by labeling target analyte 102 with a redox reagent 118, sensing an electrochemical reaction at a first electrode region 124, and photonically reporting the sensing of the electrochemical reaction via an ECL system 120 associated with a second electrode region 122.

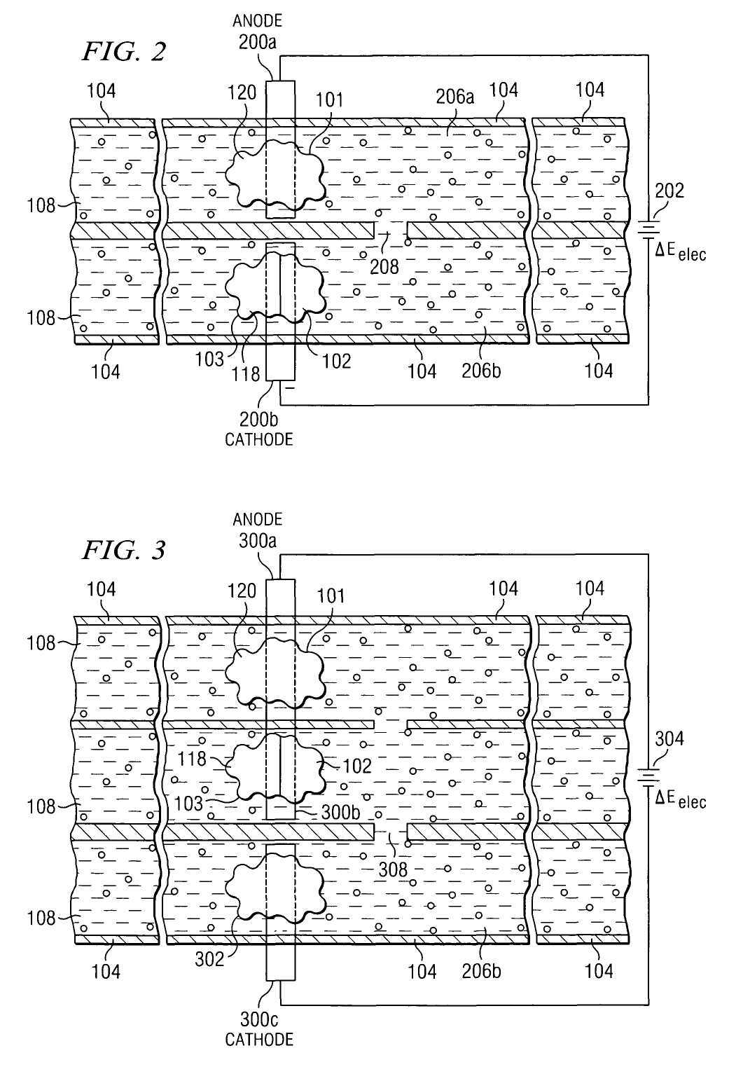

According to the teachings of one embodiment of the present invention, the reporting reaction (as denoted by reference numeral 101) associated with ECL system 120 is decoupled from the electrochemical sensing reaction (as denoted by reference numeral 103) that is facilitated by redox reagent 118. This decoupling is described in further detail below. Because system 100 requires charge balance, the teachings of the invention recognize that sensing reaction 103 and reporting reaction 101 are electronically coupled. In this manner, the number of target analytes 102 that may be detected using the highly sensitive ECL system 120 is greatly increased. In addition, because of the electronic coupling, it is possible to correlate the intensity of light 121 emitted by ECL system 120 to the concentration of target analyte 102, thereby quantifying it. System 100 may be implemented in a wireless mode, such as that shown in FIGS. 1A, 1B, 1C and 1D for example, or may be implemented in a wired mode, as described below in conjunction with FIGS. 2 and 3, for example. Other implementations are contemplated by the teachings of the invention and these are provided for example purposes only.

As illustrated in FIGS. 1A and 1B, system 100 includes a test container 104 housing a bipolar electrode 106 and an electrolyte solution 108. System 100 also includes a voltage source 110 and a detector 114.

Test container 104 may be any suitable container adapted to house bipolar electrode 106 and electrolyte solution 108. Container 104 may be any suitable size and be formed from any suitable material using any suitable manufacturing method. The container may take the form of a channel, a microchannel, a chamber, a well, a tube, a capillary and the like, each of which may be of any suitable dimension. For example, the length, width, and depth of container 104 may be anywhere from 0.1 microns to several centimeters or more. In addition, container 104 may be formed from any suitable material, such as a polymer, an elastomer, a plastic, ceramic, glass, quartz, silicon, and joint composites. Although only one container 104 is illustrated in FIGS. 1A and 1B, system 100 may include multiple containers 104. Furthermore, each may contain one or more bipolar electrodes 106, as illustrated in FIGS. 1C and 1D.

Bipolar electrode 106 is any suitably sized electrode formed from any suitable material, such as carbon, conducting ink, conducting polymer, any suitable metals, conducting oxides, and semiconductor material. Bipolar electrode 106 may be formed using any suitable methods, such as conventional lithographic methods used in the semiconductor industry, sputtering, evaporation, electron beam deposition, screen printing, electro- or electroless deposition, and painting. Bipolar electrode 106 may also be preformed and then be located in the container 104. Bipolar electrode 106 includes first electrode region 124 and second electrode region 122. In the illustrated embodiment, first electrode region 124 acts as a cathode and second electrode region 122 acts as an anode; however, in other embodiments, first electrode region 124 acts as an anode and second electrode region 122 acts as a cathode. Bipolar electrode 106 may also vary in the area at each end of the electrode, thus first electrode region 124 may be smaller or larger than second electrode region 122 by varying the width of the electrode. For example, bipolar electrode 106 may have the shape of the letter “T”. This provides control over the relative current density at each end, and therefore may be used to enhance the ECL light signal by concentrating the signal in a smaller area, and by providing a larger electrode area for reaction by redox reagent 118, by having, according to FIG. 1, a wider first electrode region 124 and a narrower second electrode region 122.

Electrolyte solution 108 may be comprised of any suitable electrolyte salt dissolved in water, an organic solvent, an aqueous/organic solvent solution, an ion-conducting polymer, molten salt, liquid ammonia, liquid sulfur dioxide, and any suitable supercritical fluids. Electrolyte solution 108 may be introduced into container 104 using any suitable methods. In one embodiment, electrolyte solution 108 contains both target analyte 102 labeled with redox reagent 118 and ECL system 120.

Target analyte 102 is any suitable molecule(s) of which it is desired to analyze by system 100. For example, target analyte 102 may be DNA, RNA, oligonucleotides, proteins, peptides, enzymes, antibodies, antigens, sugars, (oligo)saccharides, lipids, steroids, hormones, small organic molecules, neurotransmitters, drugs, cells, reagents, process intermediates, reaction products, byproducts, process stream components, pollutants, or other suitable species. Target analyte 102 may either be electroactive, in which case it intrinsically contains redox reagent 118, or target analyte 102 may be nonelectroactive wherein labeling by redox reagent 118 may be required. The labeling of target analyte 102 with redox reagent 118 may be by any suitable labeling method, such as direct or indirect labeling, covalent labeling, non-covalent labeling, electrostatic labeling, in-situ labeling, conversion by enzymatic reaction, and conversion by chemical reaction. Where multiple analytes are to be detected in one measurement, different redox labels may be used.

Redox reagent 118 is any suitable redox-active molecule(s). A redox-active molecule is a molecule that can be easily oxidized or reduced. One example of a redox molecule is benzyl viologen (BV²⁺), which is readily reduced by two electrons in two successive one electron events. Other examples include ferrocenes, quinones, phenothiazine, viologens, porphyrins, anilines, thiophenes, pyrroles, transition metal complexes, metal particles, other particles such as polystyrene spheres that can host multiple redox molecules, and the like. Redox labels capable of exchanging more than one redox equivalent (i.e., electron) in a redox reaction serve to amplify the signal in the subject invention. The function of redox reagent 118 is described in further detail below; however, generally, when redox reagent 118 associated with target analyte 102 passes within the vicinity of first electrode region 124 then a redox reaction occurs, which causes a corresponding redox reaction of ECL system 120 at second electrode region 122, thereby emitting light 121 to be detected by detector 114.

ECL system 120 may be any suitable electrochemiluminescent system. An ECL system is a compound or combination of compounds that can be induced to luminesce (emit light) by redox events. An example of an ECL system is a ruthenium or osmium chelate combined with a trialkylamine. In a particular embodiment of the present invention, ECL system 120 includes a ruthenium tris-bipyridyl compound (“Ru(bpy)₃²⁺”) and a tripropylamine (“TPA”). The function of ECL system 120, which is described in further detail below, is to generate light 121 in response to an electrochemical reaction, such as a redox reaction. Light 121 is detected by detector 114. Accordingly, an optically clear window 112 may be associated with container 104 to allow light 121 emitted from ECL system 120 to be detected by detector 114. Window 112 may be any suitable size and may be formed in container 104 using any suitable material and method. The test container itself may be fabricated from optically clear materials, such as glass or appropriate thermoplastics, to allow light 121 to be detected by detector 114. The test container may be a well or other such form, wherein the container has an opening to the outside by which the light signal may pass to the detector directly.

Detector 114 may be any suitable detector operable to detect light 121 emitted from ECL system 120. For example, detector 114 may include visual observation, a photomultiplier tube, a charge coupled device such as a CCD array, a CMOS array, a photodiode, and a camera. Detector 114 is positioned adjacent window 112 in order to detect light 121.

Voltage source 110 may be any suitable device operable to apply a suitable voltage across the length of container 104, thereby introducing an electric field to electrolyte solution 108. The electric field that is developed in the electrolyte solution across the length of the electrode is shown as ΔE_{field} in FIGS. 1A-1D. If the potential difference of electrolyte solution 108 present at first electrode region 124 and second electrode region 122 reaches a critical value, Faradaic processes occur at both ends of bipolar electrode 106. This critical potential (E_{crit}) depends on many factors, such as the concentration of redox reagent 118 present in electrolyte solution 108, the temperature, the magnitude of the heterogeneous electron-transfer rate constant for the two half reactions, mass transport rates, junction potentials, and the like. However, typically, E_{crit} is roughly equal to the difference in the formal potentials of the redox processes occurring at first electrode region 124 and second electrode region 122.

When the difference in the potential of electrolyte solution 108 along the length of bipolar electrode 106 (ΔE_{elec}) is less than E_{crit}, then current within container 104 surrounding bipolar electrode 106 is carried by ions in electrolyte solution 108. However, when the potential difference ΔE_{elec} exceeds E_{crit}, then it is energetically more favorable for Faradaic processes to occur at the two ends of bipolar electrode 106 (i.e., first electrode region 124 and second electrode region 122) and for the current to be carried by electrons within bipolar electrode 106. In this manner, when a redox reaction occurs to redox reagent 118 then a correlated redox reaction occurs at ECL system 120, which causes the emission of light 121 to be detected.

In one embodiment of the invention, an ion-permeable barrier 116 exists in container 104, thereby providing separated sample compartments. Barrier 116 functions to separate the redox reagents (i.e., analytes) associated with sensing reaction 103 from the ECL system associated with reporting reaction 101, while still allowing ionic coupling. Any suitable ion-permeable barrier may be utilized, such as a liquid-liquid junction, a salt bridge, an ionophoric membrane, and ion-permeable sol-gel barrier. Barrier 116 may also be a narrow opening connecting the separate compartments. While the opening may be of the same size as the container in one dimension, in at least one dimension the opening is smaller than the corresponding dimension in the container. The narrow opening prevents substantial mixing of the sensing reaction 103 with the reporting reaction 101. In an embodiment where barrier 116 is utilized, the salts, buffers and solvent comprising electrolyte solution 108 associated with sensing reaction 103 may be the same or may be different from the salts, buffers and solvent comprising the electrolyte solution associated with reporting reaction 101.

FIG. 1C is a schematic plan view illustrating system 100, in which bipolar electrodes of varying length are utilized. The embodiment shown in FIG. 1C includes electrodes 106a, 106b and 106c that differ in length. The magnitude of the electric field that develops in electrolyte solution 108 across electrodes 106a, 106b and 106c varies roughly in proportion to the particular electrode length. Accordingly, each electrode of different length provides a different ΔE_{elec}. In the illustrated embodiment, different redox labels having different redox potentials may be distinguished within a mixture according to the relative intensity of emitted light from the different bipolar electrodes 106a, 106b and 106c. For example, a certain redox label 118 may be characterized by an E_{crit} that is only exceeded by ΔE_{elec} of the longest electrode, i.e., electrode 106c. In this embodiment ECL system 120 is activated and emits light at second electrode region 122c of electrode 106c and not electrodes 106a or 106b. A second redox label 118 used to label a different analyte, however, may be characterized by an E_{crit} that is exceeded by ΔE_{elec} of the two longer electrodes, i.e., electrodes 106b and 106c. In this embodiment ECL system 120 is activated and emits light at second electrode regions 122b and 122c of electrodes 106b and 106c, respectively, but not electrode 106a. Embodiments are contemplated in which the lengths of electrodes are adjusted for distinguishing between multiple redox labels, and the pattern of emitted light from the multiple electrodes is used to determine the presence of analytes within a mixture.

FIG. 1D is a schematic plan view illustrating system 100, in which an array of bipolar electrodes 106a, 106b, 106c and 106d are utilized. The “array” embodiment of FIG. 1D operates in a similar manner to the embodiments shown in FIGS. 1A and 1B except for the fact that multiple electrodes are being utilized.

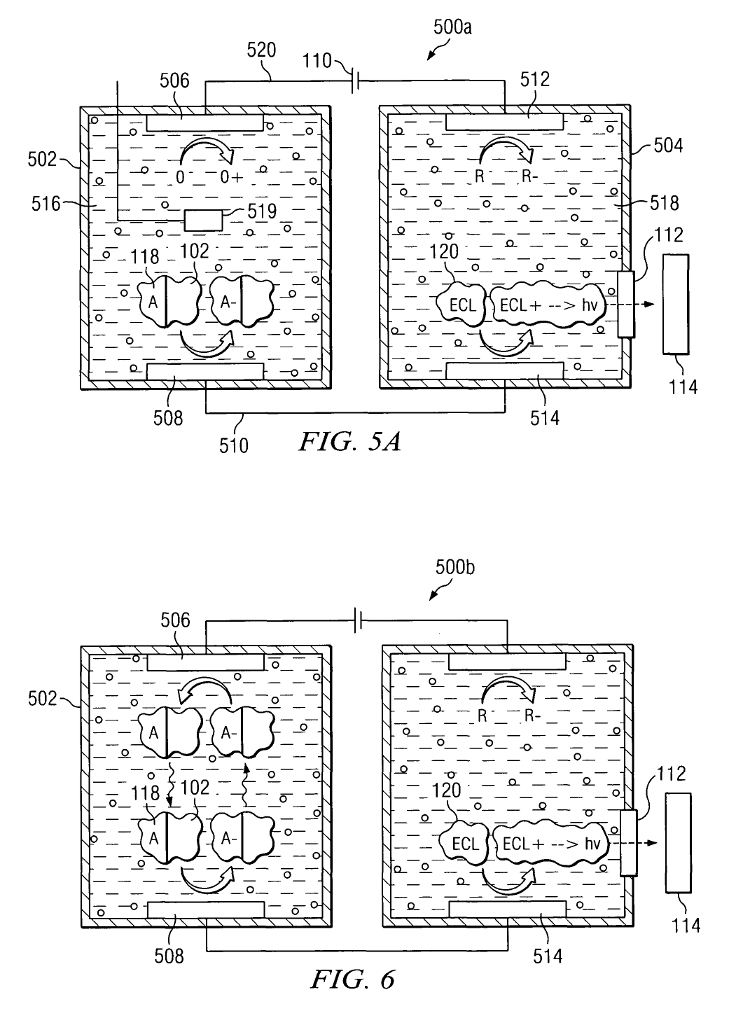

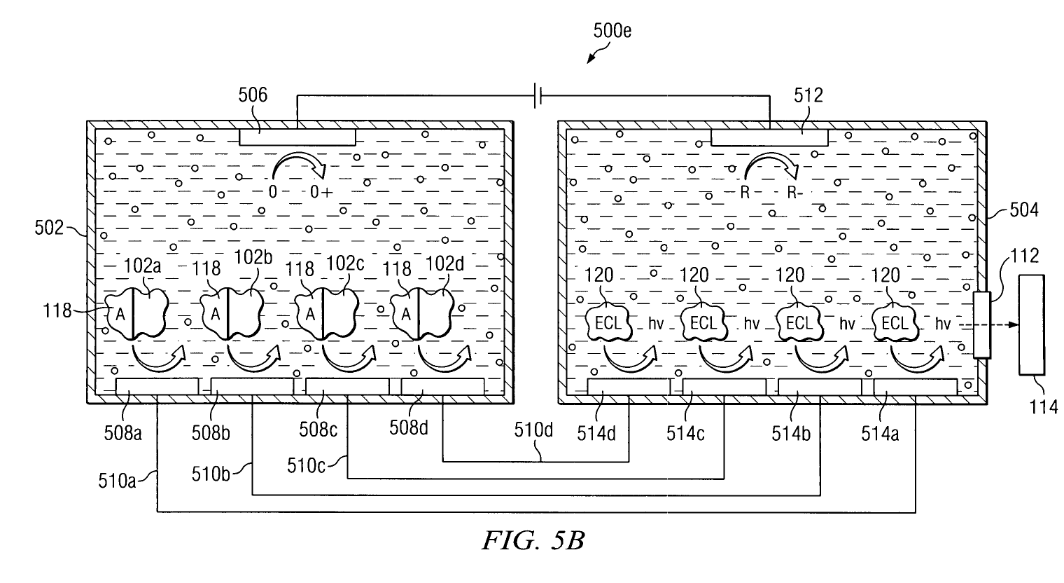

This array of electrodes may be utilized for the detection of multiple target analytes within the same sample. In this embodiment, one region of each bipolar electrode is made analyte-specific by the association of a recognition element to that region. The recognition element selectively responds to or selectively binds one of the multiple analytes of interest. This recognition element may be an ion-selective membrane, or any suitable molecule that selectively binds another, such as DNA, RNA, PNA and other nucleic acid analogues, antibodies, antigens, receptors, ligands, and the like, including combinations of such recognition elements. The localized generation of signals is discussed below in conjunction with FIG. 5A.

A brief description of the operation of the wireless embodiment illustrated in FIGS. 1A and 1B, assuming that container 104 is already fabricated along with bipolar electrode 106, window 112, and barrier 116, is as follows. Target analyte 102 is first labeled with redox reagent 118 and is mixed with electrolyte solution 108. In addition, ECL system 120 is mixed with electrolyte solution 108. As described above, the electrolyte solution 108 used for target analyte 102 and the associated redox reagent 118 and the electrolyte solution 108 used for ECL system 120 may or may not be of the same type. Electrolyte solution 108 containing target analyte 102 and associated redox reagent 118 is introduced into a compartment 105b of container 104 and electrolyte solution 108 containing ECL system 120 is introduced into a compartment 105a of container 104. Detector 114 is then appropriately positioned adjacent window 112.

Voltage source 110 then imposes an electric field across the length of container 104. This causes a potential difference in electrolyte solution 108 between first electrode region 124 and second electrode region 122, which causes ionic flow between compartments 105a and 105b via chemical barrier 116. When the potential difference ΔE_{elec} exceeds E_{crit}, as described above, then current starts to flow in bipolar electrode 106 from second electrode region 122 to first electrode region 124. When target analyte 102, optionally labeled with redox reagent 118, passes, by diffusion or bulk convection, within the vicinity of first electrode region 124 then a redox reaction occurs. Accordingly, redox reagent is reduced if first electrode region 124 acts as a cathode or oxidized if first electrode region acts as an anode. Assuming first electrode region 124 acts as a cathode, redox reagent 118 accepts an electron from bipolar electrode 106 and because system 100 requires charge balance, ECL system 120 gives up an electron to bipolar electrode 106. This redox reaction of ECL system 120 causes light 121 to be emitted through window 112. Detector 114 then detects light 121, which signals that target analyte 102 has been detected. The intensity of light 121 is related to the number of redox molecules detected near first electrode region 124 enabling the determination of the amount of target analyte.

The decoupling of reporting reaction 101 from sensing reaction 103 leads to a number of technical advantages in the subject invention. One such technical advantage is that system 100 employs separate reactions for the sensing and the reporting processes. Prior systems focused on reactions taking place at the “working” electrode and ignored the activity at the “counter” electrode. As a result, a single reaction had to provide simultaneously both the sensing and reporting functions. In contrast, the teachings of one embodiment of the present invention focus on the light being emitted by an ECL system occurring at one electrode region (i.e., the counter electrode), while the electrochemical sensing reaction is taking place at another electrode region (i.e., the working electrode). This allows for better quality control of the detection of analytes and also reduces and/or eliminates problems associated with using an ECL reaction in the sensing reaction, in which the ECL redox molecules are used as the label for the target analyte, i.e., simultaneously serve as both label and reporter.

Prior systems also required that both the sensing and reporting processes be performed in a single sample compartment. In contrast, the teachings of some embodiments the invention provide for the separation of the sensing and reporting processes, thus permitting the independent optimization of each redox process with respect to solvent, electrolyte concentration, and composition and other components so as to maximize the efficiency of light emission by the ECL system, while maintaining appropriate pH, ionic strength, and other solvent conditions that may be necessary for the sensing reaction. Embodiments of the invention in which the sensing and reporting reactions are performed in separate compartments at separate electrodes are described below in conjunction with FIGS. 2 and 3.

FIG. 2 is a schematic plan view illustrating a wired embodiment of system 100 in which two electrodes 200a, 200b are utilized. Electrodes 200a and 200b may be any suitable size and any suitable shape and be formed from any suitable material such as was described for bipolar electrode 106. The electrodes 200a and 200b may be of similar shape and area as illustrated in FIG. 2, or the electrode areas may differ in order to enhance the ECL signal generated by the system as discussed above. The area of one electrode may be twice, ten times, one hundred times, even one thousand times larger than the other electrode. The electrode shapes may be varied according to the needs of the device for manufacture, packaging, size requirements, sensitivity, and the like, according to the application. The embodiment illustrated in FIG. 2 is similar to the embodiment illustrated in FIGS. 1A and 1B except for the fact that bipolar electrode 106 is replaced by electrodes 200a and 200b. In addition, electrodes 200a and 200b are electronically coupled to one another via a voltage source 202, which may be a battery or other suitable voltage source operable to apply a potential difference between electrodes 200a and 200b. As illustrated in FIG. 2, electrode 200a acts as an anode and electrode 200b acts as a cathode; however, electrode 200a may act as a cathode and electrode 200b may act as an anode depending on the types of redox molecules used for redox reagent 118 and ECL system 120.

Similar to the embodiments illustrated in FIGS. 1A-1D, sensing reaction 103 is associated with one of the electrode regions while reporting reaction 101 is associated with the other of the electrode regions. In the embodiment illustrated in FIG. 2 however the electrode regions are separate electrodes that are located in two adjacent compartments 206a and 206b. A narrow opening 208 between the compartments permits the two compartments to be ionically coupled for the preservation of charge balance. The size of opening 208 is a compromise between the need to have ionic communication between the compartments and the need to keep substantially separate the solutions of each compartment. Where a narrow opening is preferred, opening 208 may be small with respect to at least a dimension of the container geometry. For example, opening 208 may be of the same height as the compartments to either side, but the width of opening 208 may be less than the width of the connected compartments. In an alternative embodiment (not shown), there may also be a ion-permeable barrier between compartments 206a and 206b that functions in a similar manner to chemical barrier 116 in the wireless embodiment.

In another embodiment of the invention, the samples flow through the container and a barrier between compartments exists upstream of the electrodes and an opening between compartments exists downstream of the electrodes. In another embodiment in which two or more sample streams flow past the electrodes, a barrier between compartments exists upstream of the electrodes and past the electrodes the two or more streams merge. In yet another embodiment, no physical barrier exists between the streams upstream or downstream of the electrodes, and streams are merged from separate inlets into a main channel under laminar flow conditions such that bulk separation is maintained.

Other configurations of electrodes and compartments, including configurations having multiple sensing reaction compartments associated with a single compartment for reporting reaction 101, are contemplated in another embodiment of the present invention. The operation of the embodiment illustrated in FIG. 2 is similar to the operation of the embodiment shown in FIGS. 1A-1D above. One operational difference is that voltage source 202 applies a potential difference between the electrodes 200a and 200b, rather than across the container as described above.

FIG. 3 is a schematic plan view illustrating a wired embodiment of system 100 in which three electrodes 300a, 300b, and 300c are utilized. Electrodes 300a, 300b and 300c may be any suitable size and any suitable shape and be formed from any suitable material, such as was described for bipolar electrode 106 and for electrodes 200a and 200b. The embodiment illustrated in FIG. 3 differs from the embodiments illustrated in FIGS. 1A and 2 in that the detection of target analyte 102 is an inverse detection. In other words, in the embodiments illustrated in FIGS. 1A and 2, the intensity of light 121 increases when the electrochemical sensing reactions occur as opposed to the embodiment of FIG. 3 in which the intensity of light 121 decreases when the electrochemical sensing reactions occur. This is described as follows.

In the illustrated embodiment, electrode 300a is associated with ECL system 120, electrode 300b is associated with target analyte 102 and redox reagent 118, and electrode 300c is associated with a sacrificial redox reagent 302. Sacrificial redox reagent 302 is comprised of redox molecules that are easily reduced or oxidized by an electrode. The presence of sacrificial redox reagent 302 at electrode 300c causes a corresponding redox reaction of ECL system 120 at electrode 300a when a sufficient potential difference exists between electrodes 300a and 300c. This then causes the emission of light 121 through window 112 that is detected by detector 114, similar to that described above. Ionic coupling between the compartments is provided by narrow openings 308 between the compartments.

The detection of target analyte 102 labeled with redox reagent 118 is described as follows. Electrode 300a and 300b are directly electronically coupled and thus are substantially at the same potential. When target analyte 102 and redox reagent 118 pass within the vicinity of electrode 300b, then redox reactions occur to redox reagent 118 since electrode 300b is held at an appropriate potential for such reaction. In this manner, because electrodes 300a and 300b are directly coupled the current that passes from electrode 300c is shared between electrodes 300a and 300b. The redox molecules associated with both ECL system 120 and redox reagent 118 are competing for electrons. Thus, the intensity of light 121 being emitted from ECL system 120 decreases when a target analyte 102 (optionally labeled with redox reagent 118) encounters electrode 300b, thereby indicating the detection of target analyte 102. Other configurations of electrodes and microchannels are contemplated by this embodiment of the present invention.

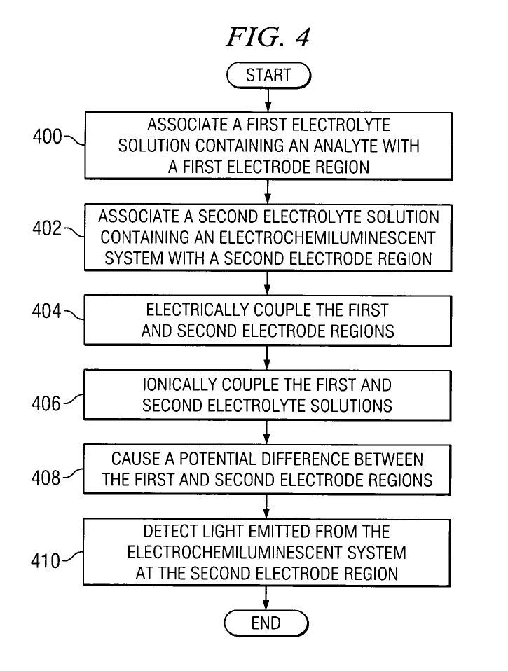

FIG. 4 is a flowchart illustrating a method for detecting the presence of target analyte 102 according to one embodiment of the present invention. The method begins at step 400 where a first electrolyte, such as electrolyte solution 108, containing target analyte 102 is associated with first electrode region 124. In one embodiment, target analyte 102 is labeled with redox reagent 118. A second electrolyte, such as electrolyte solution 108, containing ECL system 120 is associated with second electrode region 122 at step 402. As described above, the first and second electrolytes may be of the same type or may be of a different type.

First electrode region 124 and second electrode region 122 are electronically coupled at step 404. In the wireless embodiment shown in FIGS. 1A and 1B, this includes bipolar electrode 106 or in the wired embodiment shown in FIGS. 2 and 3 this includes separate electrodes electronically coupled with a circuit and a voltage source. The first and second electrolytes are ionically coupled at step 406. The first and second electrolytes are ionically coupled if the same electrolyte solution 108 is utilized and there is no chemical barrier between them. In an embodiment where a chemical barrier exists, then the ionic coupling results from a barrier that allows ionic coupling but prevents chemical coupling of the electrolytes. For example, the chemical barrier may include a liquid-liquid junction, a salt bridge, an ionophoric membrane, or an ion-permeable sol-gel barrier.

A potential difference is caused between first electrode region 124 and second electrode region 122 at step 408. This may include imposing an electric field across the electrolyte solution contacting the electrode for the wireless embodiment in FIGS. 1A and 1B or may include applying a voltage between electrodes in the wired configuration of FIGS. 2 and 3. When the potential difference exceeds E_{crit} then light 121 is emitted from ECL system 120. Accordingly, at step 410, light 121 emitted from ECL system 120 at the second electrode region 122 is detected by detector 114. The intensity of light 121 is correlated with the number of redox molecules present at first electrode region 124. This ends the method as outlined in FIG. 4.

FIGS. 5A through 8 are schematic diagrams of various embodiments of an alternate system 500 for detecting the presence of target analyte 102 in which a sample compartment 502 and a signal compartment 504 are isolated from one another. Systems 500a, 500b, 500c and 500d are similar in function in that the presence of target analyte 102 introduced into sample compartment 502 causes a redox reaction to occur that permits current to flow through signal compartment 504. Signal compartment 504 includes a light-emitting source, which, when current flows through signal compartment 504, is induced to emit light and that optical signal is recorded by detector 114. System 500e exemplifies a system embodiment for detecting the presence of multiple target analytes 102 for multiplexed detection. Multiple analytes separately associate with the plurality of bipolar electrodes in sample compartment 502, and the redox labels associated with each of the analytes causes current to flow through signal compartment 504. Signals (light) are emitted via the respective plurality of light-emitting sources associated with the plurality of bipolar electrodes in the signal compartment.

Referring to FIG. 5A, system 500a illustrates the light emitting source as being ECL system 120. In the illustrated embodiment, sample compartment 502 includes an electrode 506 and a first end 508 of a bipolar electrode 510. Signal compartment 504 includes an electrode 512 and a second end 514 of bipolar electrode 510. Electrodes 506, 512 are connected to voltage source 110, such as a battery, a power supply, or other suitable voltage source by which a potential difference may be imposed between an electrolyte solution 516 in sample compartment 502 and an electrolyte solution 518 in signal compartment 504. In addition, a circuit 520 associated with voltage source 110 may also provide voltage regulation and potential waveform generation.

System 500a may optionally include a reference electrode 519. In this case a potentiostat would be used for circuit 520, with electrode 506 connected to the potentiostat as the working electrode and electrode 512 connected as the counter electrode. An operation of this embodiment is described further below.

Electrodes 506, 512 may be fashioned from the same or different materials, as described above. Bipolar electrode 510 may be constructed by connecting (“shorting”) two independently fashioned electrodes with a conductor, or it may be constructed as one monolithic electrode with first and second ends 508, 514 exposed in sample and signal compartments 502, 504. The function of bipolar electrode 510 remains the same although the design or fabrication method of system 500a may favor one format over the other.

Signal compartment 504 also includes optically transparent window 112, such that the photonic signal generated within signal compartment 504 may be recorded by detector 114. In a particular embodiment, detector 114 is mounted within signal compartment 504. Optical window 112 in this embodiment would be integral to detector 114.

A sample solution suspected of containing target analyte 102 is associated with sample compartment 502. The sample solution also contains electrolyte to provide ionic conduction necessary for the electrochemical process. Also, redox reagent 118 associated with target analyte 102 is provided. Electrolyte solution 518 contains ECL system 120 in signal compartment 504.

One embodiment of system 500a provides for associating target analyte 102, and thus redox reagent 118 associated with target analyte 102, with first end 508 of bipolar electrode 510. Association, or localization, of target analyte 102 may serve to concentrate target analyte 102, sequester target analyte 102 from the bulk solution or from a flowing sample stream, or to separate target analyte 102 from other similar species. The localization occurs via an analyte-specific recognition element.

The analyte-specific element may be any suitable membrane that responds selectively to its environment, such as an ion-selective membrane. The analyte-specific element may also be any suitable molecule that exhibits the ability to selectively bind another molecule such as a DNA, RNA, or PNA oligomer, probe, or primer, an antibody, an antigen, a receptor, a ligand and the like. Analyte-specific responsive or binding elements are well known in the art and are commonly used in chemical and biological assays.

The analyte-specific element may be provided in a number of forms, though it will be physically located near the bipolar electrode. The elements may be bound directly to the electrode interface, or to areas adjacent to the electrode, or to both. The elements may also be bound to other solid supports, such as beads, microparticles, nanoparticles, gels, porous polymers and the like, which in turn are confined near the electrode interface. The binding of the elements may be covalent, non-covalent, electrostatic, van der Waals, physisorptive or chemisorptive. The confinement of other solid supports may physical or chemical. Physical confinement includes restraining beads within porous barriers such that fluids may be exchanged with other areas of the compartment but the beads cannot pass through the openings.

Localization of target analyte 102, in turn, serves to localize redox reagent 118 associated with that target analyte to bipolar electrode 510. Where target analyte 102 itself is electroactive, or where the target is directly labeled with redox reagents, localization is achieved by binding of the analyte.

Direct labeling of analytes may be done with redox-active molecules, redox polymers, polymers with bound redox groups, conducting polymers, redox-active particles, redox-active colloids, and the like. Redox-active particles may be generated in-situ by the electroless deposition of an oxidizable metal. For example, using analytes labeled with a gold particle, exposure of the particle to a solution of silver ions will cause the formation of silver metal on the gold particle. The deposited silver, which can be readily oxidized, then serves as redox reagent 118 in the analysis.

Target analyte 102 may also be labeled with enzymes or catalysts capable of changing the redox activity of a substrate, and the molecule possessing the new redox activity is the redox reagent 118 associated with target analyte 102 in the subject method. This latter case is an example of indirect labeling. The redox reagent 118 that is produced by the enzyme or catalyst directly labeling the target is itself not bound to the target. However, the presence of redox reagent 118 is associated with the presence of target analyte 102.

In either of the direct of indirect labeling methods, the attachment of the direct label, or the enzyme or catalyst to target analyte 102 may be done by a covalent bond or by an agent capable of a specific binding interaction with target analyte 102. The choice of binding agent depends on the nature of target analyte 102. For example, for nucleic acid targets the binding agent would be a nucleic acid or related derivative (RNA, DNA, PNA etc.), and for antigens or antibodies the binding agent would be an antibody directed at the antigen or antibody. This methodology adopts many of the features of what is commonly referred to as a sandwich assay.

In the illustrated embodiment, ECL system 120 is activated by oxidation at the anodic end of bipolar electrode 510 in signal compartment 504 and redox reagent 118 associated with target analyte 102 is reduced at the cathodic end of bipolar electrode 510 in sample compartment 502. When reference electrode 519 is not included in system 500a, this embodiment may also be practiced with either reaction occurring at the other electrode in the respective compartments; i.e. the analyte reaction may occur at electrode 506, or the ECL system reaction may occur at electrode 512. The format depends on the choice of ECL system 120 and the choice of redox reagent 118, either of which may depend on various factors, such as reagent availability, cost, sensitivity, ease of handling, and stability.

System 500a also depends on redox reactions occurring at electrodes 506, 512 in compartments 502, 504. As illustrated, electrode 506 is an anode and electrode 512 is a cathode. The redox species may be any molecule in the solution, such as the solvent, the electrolyte, or another molecule with a well-defined redox activity added to the electrolyte solution or a solid-state composition at the electrode surface. For example, the electrode surface may be coated with a silver/silver chloride composition, which is capable of supplying redox equivalents to the circuit while maintaining a stable potential.

In one embodiment, system 500a operates in the following manner. Electrolyte solution 516, suspected of containing target analyte 102, is disposed within sample compartment 502 and electrolyte solution 518 containing ECL system 120 is disposed within signal compartment 504. Redox reagent 118 associated with target analyte 102 is provided. Voltage source 110 is operated to impose a potential difference between electrodes 506 and 512. The effect is to impart a potential difference between electrolyte solutions 516 and 518. When the difference in potential between the solutions at each interface of bipolar electrode 510 increases to the point of approximately matching the difference in redox potential between redox reagent 118 and ECL system 120, Faradaic current will flow through the bipolar electrode, thus activating ECL system 120. Associated with signal compartment 504 is optical window 112 to permit the photonic signal from ECL system 120 to be recorded by detector 114.

With reference to FIG. 5B, a system 500e is described as follows, particularly with regard to differences from system 500a. In the illustrated embodiment, sample compartment 502 includes an electrode 506 and a plurality of first ends 508a-d of bipolar electrodes 510a-d. The number of bipolar electrodes may be at least two, and as many as several thousands. Signal compartment 504 includes an electrode 512 and a plurality of second ends 514a-d of bipolar electrodes 510a-d.

Analyte-specific recognition elements are associated with each of first ends 508a-d. A sample solution suspected of containing the multiple target analytes 102a-d is associated with sample compartment 502, and redox reagent 118 associated with each target analyte is provided. The redox reagents may all be the same because the identity of the bipolar electrode associated with each signal will allow correlation of the signal with the analyte.

ECL system 120 is associated with signal compartment 504, and with each second end 514a-d of the bipolar electrodes 510a-d. The light signal emitted at each bipolar electrode is recorded and correlated by position with the respective bipolar electrode in order to determine the presence or amount of each analyte in the sample compartment. In this embodiment, a pixel-based detector that is able to record all the signals simultaneously is preferred, although if only a small number of bipolar electrodes are present a detector may be scanned relative to the signal compartment to sequentially record the signals.

Referring to FIG. 6, sample compartment 502 is configured to support the redox recycling of redox reagent 118 associated with target analyte 102. Redox reagent 118 may have any of the forms discussed herein with the additional requirement that it be a chemically and kinetically reversible species. Redox recycling is a well-studied phenomenon in which a reversible redox reagent moves between two closely spaced electrodes, one held at a reducing potential and the other held at an oxidizing potential, with respect to the redox reagent. In the illustrated embodiment, after undergoing an electron transfer reaction with electrode 506, redox reagent 118 diffuses to electrode 508 wherein the reverse electron transfer reaction occurs, and returns redox reagent 118 to its original state. The cycle may thus be repeated. As the distance between electrodes 506 and 508 decreases the transit time for redox reagent 118 decreases, and the net current through sample compartment 502 increases. A noticeable increase in current begins as the characteristic distance between electrodes 506 and 508 approaches approximately 15 um. The increase may be at least a factor of five as the distance decreases to approximately 5 um. This increase in current facilitates an enhanced signal from ECL system 120 with, for example, increased intensity and better sensitivity.

In one embodiment, as implied by FIG. 6, the electrodes 506 and 508 are arranged in a plane-parallel geometry with a narrow gap between the electrode interfaces. In an alternate embodiment, electrodes 506 and 508 may be incorporated as closely-spaced, co-planar electrodes. To maximize the amplification effect gained from the redox cycling, the area of close approach for two such electrodes is maximized by arranging the two electrodes in an interdigitated layout.

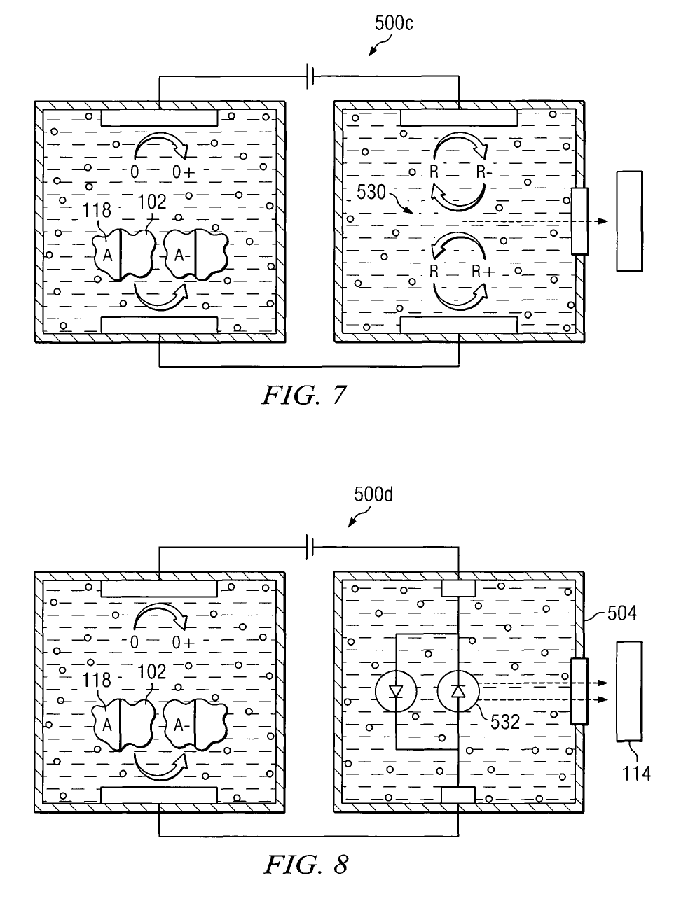

FIG. 7 illustrates a system 500c similar to system 500a and 500b discussed above, but with an alternate form of ECL system 120 in signal compartment 504. Eelectrochemiluminescent signals are generated by a so-called ‘annihilation’ reaction, as denoted by reference numeral 530. In such a reaction, the oxidized state and the reduced state of a luminescent molecule are separately generated. When they meet the two react by transfer of an electron from the reduced to the oxidized molecule to produce two neutral species, one of which adopts an electronically excited state. The molecule in the excited state returns to the ground state with a photon being emitted with an efficiency characteristic of the photophysical properties of the lumninescent molecule. The ECL system may be solution-based, comprising a solvent, electrolyte salts and a redox-active lumophore, such as for example ruthenium tris(bipyridine), diphenylanthracene, and rubrene. The ECL system may also comprise thin films of ion-conducting polymers and electrolyte interspersed with a lumophore, such as a conducting polymer, exemplified by poly(p-phenylene) or poly(p-phenylenevinylene), or a redox-polymer, exemplified by ruthenium complex-based polymers.

FIG. 8 illustrates a system 500d in which the light-emitting source in signal compartment 504 are solid-state elements 532. Two of the rectifying emitters are provided, in opposite orientations, to account for the flow of electrons in either direction. For example, light-emitting diodes (“LEDs”) and laser diodes may function within system 500d to complete the conversion of the redox signal occurring in sample compartment 502 to the photonic signal generated in signal compartment 504. The current passed by redox reagent 118 associated with target analyte 102 is converted by such elements as LED's and laser diodes to emitted light, which is then recorded by detector 114.

The basic structure of an LED comprises a stack of at least two layers sandwiched between two electrodes (a cathode and an anode). For a semiconductor LED, the standard format in commercial use, the stack comprises an n-doped semiconductor and a p-doped semiconductor. For the more recently developed organic semiconductor, the stack comprises an electron-transport layer, a hole-transport layer, an emission layer and typically an electron-transport layer. When an appropriate voltage is applied across the electrodes, and in relation to the amount of current available to flow, electrons and holes will meet and recombine at the n-p junction or in the emissive layer, respectively, and emit light as a result. Organic and semiconductor LED's may be fashioned to emit visible or infrared light. Detector 114 would thus be selected for sensitivity to the appropriate wavelength range as required by the light-emitter.

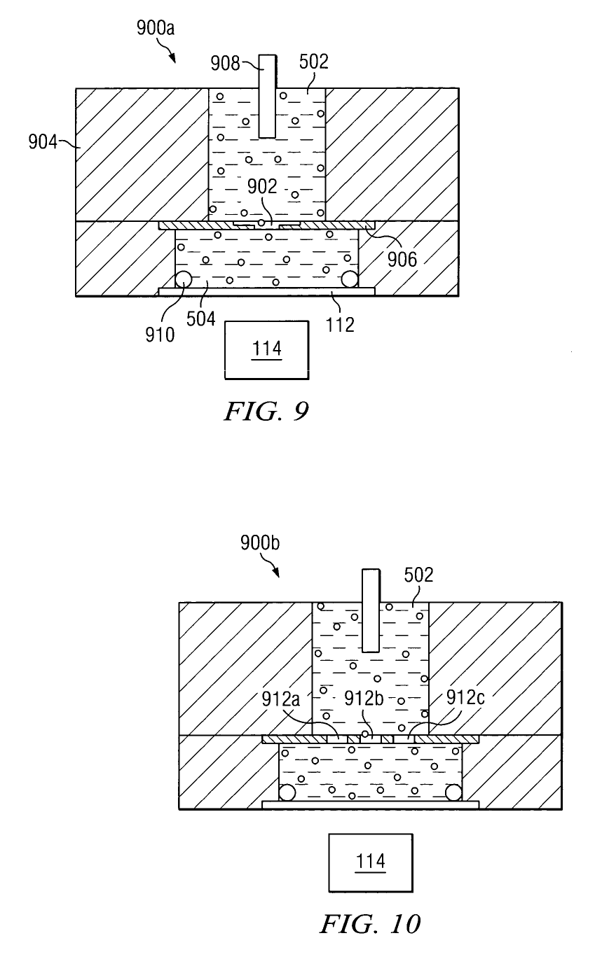

FIGS. 9 through 12 are schematic diagrams of various embodiments of another alternate system 900 for detecting the presence of target analyte 102.

FIG. 9 is a cross-sectional view of a system 900a for detecting the presence of target analyte 102 that includes a bipolar electrode 902 spanning between sample compartment 502 and signal compartment 504. In the illustrated embodiment, sample compartment 502 and signal compartment 504 are vertically arranged in a housing 904. Sample compartment 502 is in the upper portion of housing 904, and signal compartment 504 is in the lower portion. A barrier 906 lies between sample compartment 502 and signal compartment 504 and serves to physically separate the compartments. In some embodiments, barrier 906 ionically isolates the compartments, and in other embodiments, barrier 906 may provide ionic communication between the compartments.

In one embodiment, bipolar electrode 902 has one region exposed to sample compartment 502 and the opposite region exposed to signal compartment 504. The areas of each region of bipolar electrode 902 may be substantially the same, or the areas may differ in order to control the current density at each region.

Sample compartment 502 includes an electrode 908 and signal compartment 504 includes an electrode 910. These electrodes are connected to an external voltage source 110 (not illustrated). By controlling the potential difference between electrodes 908 and 910, the potential difference developed across bipolar electrode 902 is controlled. Electrode 908 may be fashioned from any suitable conductor, and may take any suitable form, such as a disc, pin, tube, ring and the like descending from a lid or gantry, and a conductor adhered to the wall of sample compartment 502. Electrode 910 may be likewise fashioned, with the additional consideration that electrode 910 be physically disposed to allow photon signals to propagate unblocked from the light emitting source, through optical window 112 and to detector 114.

FIG. 10 illustrates a cross-sectional view of a system 900b. The general construction of system 900b is similar to system 900a of FIG. 9; however, system 900b includes a plurality of bipolar electrodes 912a, 912b and 912c. Although only three bipolar electrodes are illustrated, the present invention contemplates any suitable number of bipolar electrodes. In one embodiment, bipolar electrodes 912a, 912b and 912c are used for the detection of a single target analyte, such as target analyte 102.

In another embodiment, bipolar electrodes 912a, 912b and 912c are used for the detection of multiple target analytes within the same sample. The number of bipolar electrodes may be as few as two, as many as twenty-five, or even as many as several hundreds or several thousands. The layout depends upon the number of bipolar electrodes and other factors, such as the fabrication method, the desired application and the like, but typically includes a linear array positioned along a channel or an ordered two-dimensional array positioned within a chamber. One of the multiple analytes may be an internal control. In this embodiment, the region of each bipolar electrode associated with sample compartment 502 is each associated with a different analyte-specific recognition element. Each element serves to localize one of the multiple target analytes of interest, and thus the associated redox reagents with each bipolar electrode, as described above.

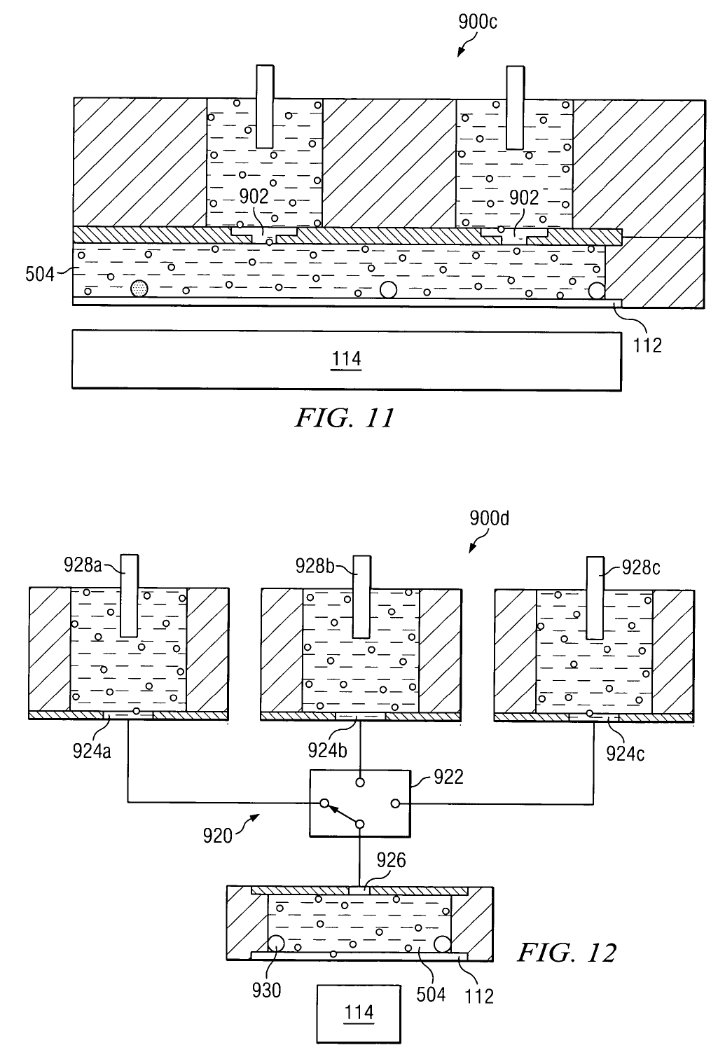

FIG. 11 shows a cross-sectional view of a system 900c having a plurality of sample compartments. Any suitable number of sample compartments may be utilized. System 900c may also be useful for batched sample analysis. In some cases it may be advantageous to analyze multiple samples, from the same or different source, within system 900c. For example, multiple samples from different sources may be tested for the presence or amount of the same target analyte. Or samples from the same source may be tested independently for the same target analyte (e.g., duplicate testing) or for different sets of target analytes. It is also within the scope of the invention to have a plurality of bipolar electrodes (similar to FIG. 10) within each sample compartment 502 of system 900c. Having a plurality of sample compartments also permits the simultaneous testing of standards, and positive and negative control samples.

Signal compartment 504 in the lower portion of system 900c is illustrated as a single, common, fluidicly connected compartment. The signal generated at each bipolar electrode 902 in signal compartment 504 is localized to the electrode by diffusion. Detector 114 may be an array-based photodetector, such as a camera, CCD array, photodiode array, a CMOS array, or other suitable detector. Detector 114 may also be a single element detector, such as a photomultiplier tube or a photodiode, that is moved with respect to each bipolar electrode location to read the signal generated at each location. Depending on the number of bipolar electrodes 902 to be read, the cost of system 900c, the desired read time, the sensitivity and other suitable factors regarding the performance of system 900c, either option may be used.

Signal compartment 504 may alternatively be comprised of individual signal compartments corresponding to each sample compartment. For example, a plurality of units that include a sample compartment, a signal compartment 504, a sample compartment electrode, a bipolar electrode(s), and a signal compartment electrode, as shown for example in FIGS. 9 and 10, may be arranged within such a system.

As illustrated in FIG. 12, a system 900d is illustrated. System 900d is similar to system 900c of FIG. 11; however, system 900d includes a plurality of sample compartments that are variably connected to the same signal compartment 504. This is a preferred system for the analysis of multiple samples at different points in time. In the illustrated embodiment, a single signal compartment 504 with a fixed physical relationship to detector 114 may be used for the analysis of different samples in a plurality of sample compartments. Because each sample is analyzed in a separate sample compartment, cross-contamination among samples is avoided.

System 900d includes an electrical circuit 920 with a switching function 922 to variably form the appropriate connections between first ends 924a, 924b and 924c and second end 926 of a bipolar electrode, and sample compartment electrodes 928a, 928b and 928c with a signal compartment electrode 930.

In any of the embodiments described in connection with FIGS. 9 through 12 the electrolyte solution containing ECL system 120 may be replaced with any of the light emitting sources discussed earlier in relation to FIGS. 5 through 8.

### EXAMPLES

1. Detection of Electrochemical Events by Photonic Conversion.

To demonstrate the chemical coupling of the sensing and reporting functions of one embodiment of the invention, the signal intensity from an ECL system, Ru(bpy)₃²⁺ and tripropylamine, generated at an anode is compared when coupled to two different cathodic processes:

2H⁺+2e⁻=H₂ (1)

BV²⁺+e⁻=BV⁺ (2)

Equation (1) represents proton reduction, which occurs under the conditions used in the experiments at a formal potential that is more negative than that for the reaction of equation (2), reduction of benzyl viologen to the radical cation.

Experiments were performed using an embodiment of the invention similar to that of FIG. 2 wherein the two electrode regions are separate electrodes (e.g., 200a and 200b in FIG. 2) and a voltage source (202) between the electrodes provides the potential difference. Indium tin oxide (“ITO”) electrodes were prepared on a glass substrate using standard photolithographic methods for defining a pattern, etching and removal of photoresist. The electrodes were 50 um wide, and long enough to span the width of the compartment (see below) and have connection pads protruding from the mold. A compartment was formed by joining a poly(dimethylsiloxane) mold (“PDMS”) that has a defined cavity 1.2 cm long, 750 um wide and 30 um deep, to the patterned ITO/glass substrate. Holes at both ends of the cavity extend through the PDMS layer and serve as fluid reservoirs and means for introducing electrolyte solutions into the compartment. A power supply (Hewlett-Packard, model E3620A) was connected to the pads and used to control the potential offset between the electrodes.

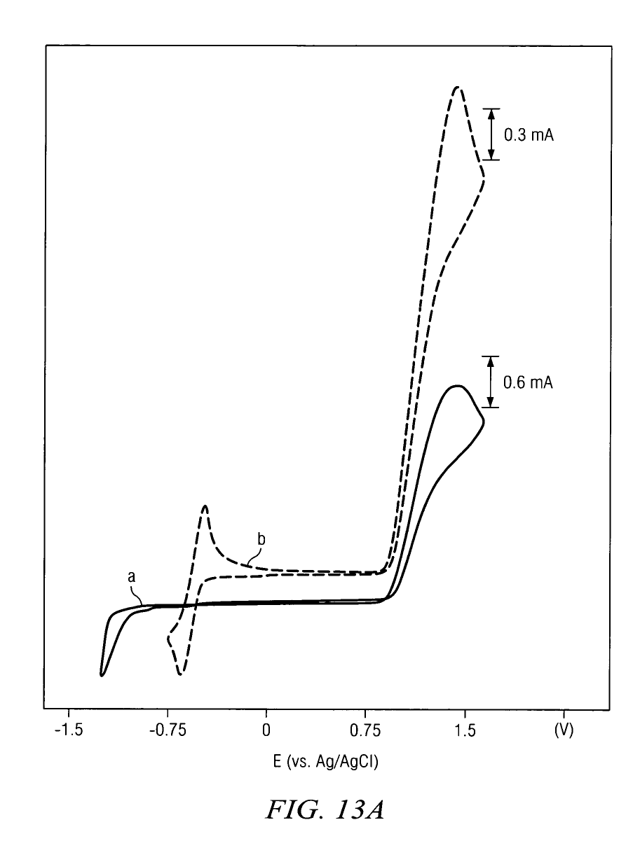

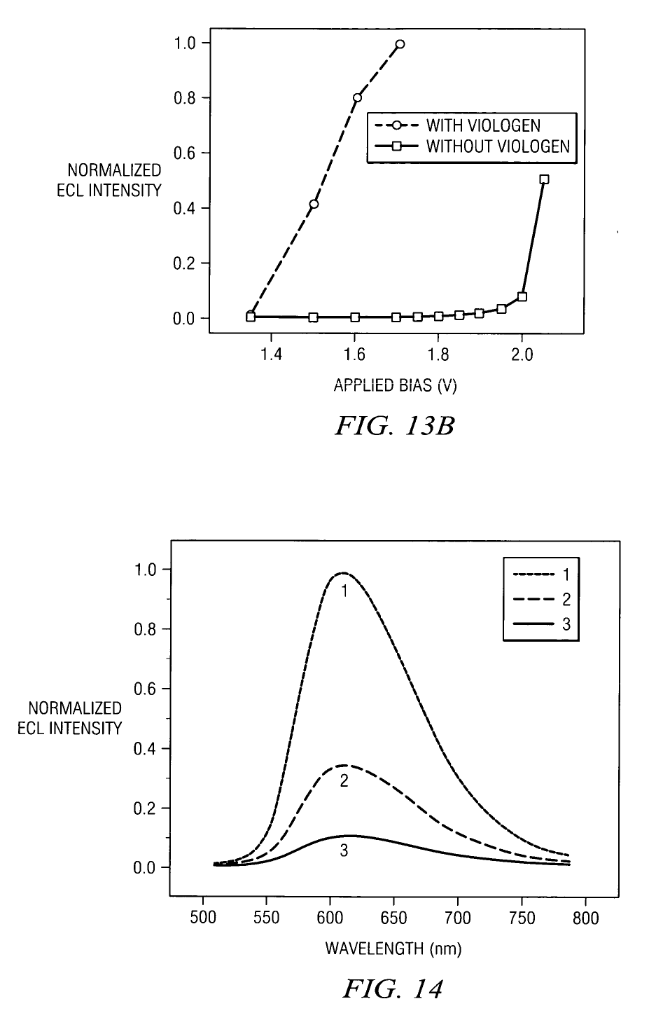

In a first experiment, the compartment was filled with electrolyte solution containing 5 mM Ru(bpy)₃Cl₂ (bpy=2,2′-bipyridine) and 25 mM tripropylamine in 0.1 M aqueous phosphate buffer, pH 6.9. In this solution, as observed in voltammogram “a” of FIG. 13A, the first reduction process, the proton reduction reaction (1), is observed at about −1.8 V vs. Ag/AgCl reference electrode. The first oxidative process is observed at about 0.8 V vs. Ag/AgCl, corresponding to oxidation reactions of the Ru(bpy)₃²⁺ and tripropylamine ECL system.

In the two-electrode experiment (FIG. 13B), the potential difference between the two electrodes was increased, and light emission was observed to begin as the bias reached about 1.8 V. This bias correlates well to the 1.88 V window between the anodic and cathodic processes for the solution.

In a second experiment, the same solution used in the first, with 5 mM benzyl viologen dichloride (BV²⁺) added, was prepared. The first oxidative process is again due to the ECL system, but the first reduction process in this solution is observed at about −0.52 V vs. Ag/AgCl, corresponding to reduction of the viologen, as observed in voltammogram “b” in FIG. 13A. Thus, in the presence of BV²⁺, the voltage difference between the onset of the cathodic and anodic processes narrows from 1.80 V to about 1.38 V.

When BV²⁺ is introduced into the compartment for the two-electrode experiment, ECL is readily observed at ΔE_{elec}=1.4 V (FIG. 13B), whereas no ECL signal had been observed at this potential bias in the solution lacking BV²⁺. The appearance of the signal at 1.4 V bias correlates well to the 1.38 V window between the anodic and cathodic processes for the solution.

As stated above, electrochemical processes occurring at the anode and cathode of either a bipolar or two-electrode configuration are linked electronically but not chemically. There is a one-to-one correspondence between the number of electrons consumed at the anode and the number provided at the cathode. It has been shown in this example that the ECL intensity at the anode reflects, or reports the occurrence of electrochemical reactions at the cathode of a two-electrode cell. This demonstrates the relationship between the sensing and reporting functions of this sensor, and that it can distinguish between two different redox-active analytes based on their redox potentials.

2. Signal Intensity as a Function of the Relative Electrode Areas

An experimental condition that leads to more turn-overs of the analyte (e.g., at the cathode) enhances the ECL intensity (e.g., at the anode). Accordingly, under otherwise identical conditions, increasing the area of the cathode results in more intense ECL. To demonstrate this, the ECL intensity was measured as a function of the relative areas of the cathode and anode using an embodiment of the invention similar to that of FIGS. 1A and 1B wherein the two electrode regions (122, 124) are at opposite ends of a bipolar electrode (106) and a potential field across the electrode generates the potential difference in the solution near each end of the electrode.

Three different bipolar electrode geometries were tested for ECL emission intensity as a function of the relative areas of the anodic and cathodic regions. In the first case the electrode is shaped like a “T” with the wide top (200 um×100 um) serving as cathode and narrow bottom (50 um wide) as anode. In the second case the electrode is a band electrode of constant width (50 um), thus the cathode and anode are equal in area. In the third case again the “T” shape is used (same dimensions as above), but with the wide top serving as the anode and the narrow bottom as cathode. In all the cases the electrodes were 500 um long. The electric field is imposed across this long axis.

A solution of 0.1 M phosphate buffer, pH 6.9, containing 5 mM Ru(bpy)₃Cl₂ and 25 mM tripropylamine was placed in contact with each electrode, and the ECL emission spectrum was recorded when a field of 1.88 V was imposed across the length of each electrode. The results are shown in FIG. 14. The highest ECL intensity was observed when the area of the cathode is large relative to the anode.

The difference between emission curves “1” and “2” demonstrates that even given the same concentration of all reagents, by increasing the current at the reporting electrode region, in this case by the design of the electrode region areas, the ECL signal is enhanced.

3. Redox Sensing and ECL-Based Photonic Reporting in a System with Isolated Sample and Signal Compartments.

In this example, the signal compartment and the sample compartment are built as two separate modules and are thus ionically isolated. The compartments are configured according to system 500a presented in FIG. 5A, without reference electrode 519. The signal compartment contained a 1 mm diameter glassy carbon electrode (514) and a coiled Ag/AgCl wire electrode (512). The compartment was filled with an electrolyte solution (518) containing 0.1 M phosphate buffer (pH 7.5), 10 mM sodium chloride, and the ECL system 10 mM tripropylamine (TPA) and 0.1 mM Ru(bpy)₃Cl₂ (bpy=2,2′-bipyridine). The sample compartment contained a 1 mm diameter glassy carbon electrode (508) and a coiled Ag/AgCl wire electrode (506), and the compartment was filled with electrolyte solution containing 0.1 M NaCl, and further containing 5.0 mM K₃Fe(CN)₆ serving as a model analyte with intrinsic redox activity. The two glassy carbon electrodes were electronically connected (“shorted”) to each other with a copper wire, and the two Ag/AgCl electrodes were connected to a programmable potential waveform generator (a computer-controlled potentiostat with the counter and reference leads jumped together: Model CHI660A, CH Instruments, Austin, Tex.). Light emission from the region of the glassy carbon electrode in the signal compartment was measured and recorded with a photomultiplier tube (PMT; Model MP 963, Perkin Elmer, Santa Clara, Calif.).

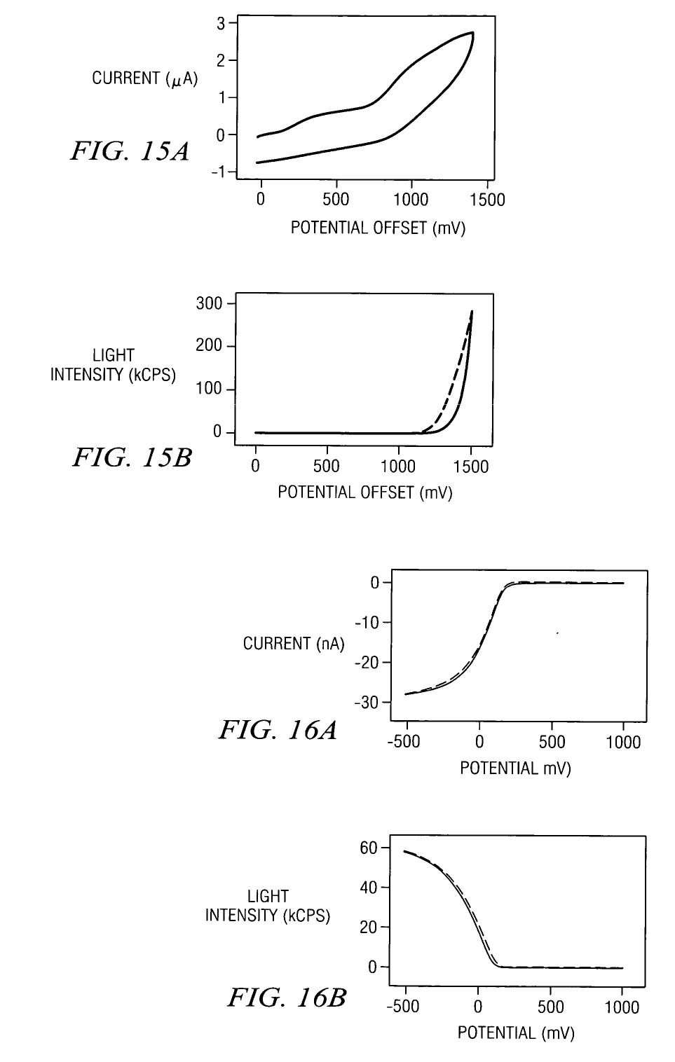

FIG. 15A shows the cyclic voltammogram (CV) obtained using the system described above by linearly scanning the potential offset imposed between the two Ag/AgCl electrodes. FIG. 15B shows the photon emission as a function of the linear sweep of the potential offset that was observed while the CV presented in FIG. 15A was recorded. FIGS. 15A and 15B together demonstrate that the electrochemically-coupled processes in each compartment together produce the analyte-specific light signal.

Embodiments of a detection system utilizing isolated sample and signal compartments may have two important practical advantages. First, the signal compartment in combination with the photon detection apparatus may be optimized independently and readily interfaced with the sample compartment unit where analyte recognition process occurs. Second, arrays of light emitter sources may be coupled to arrays of redox reactions in a practical manner without need for independently controlled circuits for each array element. Using LED's as the light emitter source, as illustrated in the following example, is also suitable for packaging the signal generation and optical imaging so that the redox reactions associated with each analyte may be monitored simultaneously and continuously.

4. Redox Sensing and LED-Based Photonic Reporting in a System with Isolated Sample and Signal Compartments.

In this example, LED light emitter sources replace the ECL system of the previous example. The system configuration is based on system 500d of FIG. 8. The sample compartment contained a 15 μm diameter glassy carbon electrode (506), a platinum electrode (508), a Ag/AgCl reference electrode (519), and the compartment was filled with electrolyte solution of 0.1 M NaCl further containing 20 mM K₃Fe(CN)₆ as the model target analyte. Two light-emitting diodes (SSL-LX5093SRC/E, DigiKey, Thief River Falls, Minn.) were connected in parallel, in opposing orientations between electrode contacts 512 and 514. A potentiostat circuit was connected to glassy carbon electrode 506 as the working electrode, Ag/AgCl electrode 519 as the reference electrode and contact 512 as the counter electrode.

FIG. 16A shows the cyclic voltammogram of the system with the reduction wave indicating the presence of the potassium ferricyanide analyte. FIG. 16B shows the emission intensity from one LED (the one passing current when cathodic current passes through electrode 506 in the sample compartment) measured concurrently with the CV of FIG. 16A. The signal generated by the LED light-emitting source indicated the presence of the redox reagent analyte in the sample compartment.

Although embodiments and examples of the present invention are described in detail, various changes, substitutions, and alterations can be made hereto without departing from the spirit and scope of the invention as defined by the appended claims.

What is claimed is:

1. A method for detecting the presence or amount of one or more analytes, comprising:
associating a first electrolyte solution containing at least one analyte with a first compartment comprising a first electrode and a second electrode;
associating a light emitting source with a second compartment comprising a third electrode and a fourth electrode;
electronically coupling the first and third electrodes;
causing a potential difference between the second and fourth electrodes; and
detecting light emitted from the light emitting source in the second compartment, thereby indicating the presence or amount of the at least one analyte in the first compartment.

2. The method of claim 1, wherein the light emitting source comprises an electrochemiluminescent (ECL) system.

3. The method of claim 1, wherein the light emitting source is a light-emitting diode.

4. The method of claim 3, wherein the light-emitting diode is a semiconductor light-emitting diode.

5. The method of claim 3, wherein the light-emitting diode emits visible light.

6. The method of claim 1, wherein the first electrode and third electrode comprise one monolithic bipolar electrode.

7. The method of claim 1, further comprising:
associating a plurality of first electrodes with the first compartment;
associating a plurality of third electrodes with the second compartment;
associating a plurality of light emitting sources with the second compartment;
electronically coupling respective first and third electrodes; and
detecting light emitted from each light emitting source in the second compartment.

8. The method of claim 7, wherein the plurality of light emitting sources are light-emitting diodes.

9. The method of claim 7, wherein the second electrode is a cathode and the fourth electrode is an anode.

10. The method of claim 7, wherein the second electrode is an anode and the fourth electrode is a cathode.

11. A method for detecting the presence or amount of an analyte, comprising:
associating a first electrolyte solution containing the analyte with a first region of a bipolar electrode;
associating a second electrolyte solution containing an electrochemiluminescent system with a second region of the bipolar electrode;
ionically isolating the first electrolyte solution from the second electrolyte solution;
causing a potential difference between the first and second electrolyte solutions; and
detecting light emitted from the electrochemiluminescent system, thereby indicating the presence or amount of the analyte at the first region of the bipolar electrode.

12. The method of claim 11, further comprising causing the first and second electrolyte solutions to have the same composition.

13. The method of claim 11, wherein associating a first electrolyte solution containing the analyte with a first region of a bipolar electrode comprises associating the first electrolyte solution containing the analyte with respective first regions of a plurality of bipolar electrodes; and
wherein associating a second electrolyte solution containing an electrochemiluminescent system with a second region of the bipolar electrode comprises associating the second electrolyte solution containing the electrochemiluminescent system with respective second regions of the plurality of bipolar electrodes.

14. The method of claim 13, further comprising causing the potential difference between the first and second electrolyte solutions to be the same for each of the plurality of bipolar electrodes.

15. The method of claim 11, wherein causing a potential difference between the first and second electrolyte solutions comprises imparting a potential difference between a first electrode associated with the first electrolyte solution and a second electrode associated with the second electrolyte solution.

16. The method of claim 15, wherein the first electrode is a cathode and the second electrode is an anode.

17. The method of claim 15, wherein the first electrode is an anode and the second electrode is a cathode.

18. The method of claim 11, wherein the first region of the bipolar electrode has a larger surface area than the second region.

19. The method of claim 13, wherein the respective first regions of the plurality of bipolar electrodes have a larger surface area than the respective second regions.

20. A system for detecting the presence or amount of one or more analytes, comprising:
a first compartment comprising a first electrode and a second electrode;
a first electrolyte solution containing at least one analyte associated with the first compartment;
a second compartment comprising a third electrode and a fourth electrode;
a light emitting source associated with the second compartment;
a conductor electronically coupling the first and third electrodes;
a voltage source operable to generate a potential difference between the second and fourth electrodes; and
a detector operable to detect light emitted from the light emitting source in the second compartment, thereby indicating the presence or amount of the at least one analyte in the first compartment.

21. The system of claim 20, wherein the light emitting source comprises an electrochemiluminescent (ECL) system.

22. The system of claim 20, wherein the light emitting source is a light-emitting diode.

23. The system of claim 22, wherein the light-emitting diode is a semiconductor light-emitting diode.

24. The system of claim 22, wherein the light-emitting diode emits visible light.

25. The system of claim 20, wherein the first electrode and third electrode comprise one monolithic bipolar electrode.

26. The system of claim 20, wherein:
the first compartment comprises a plurality of first electrodes;
the second compartment comprises a plurality of third electrodes;
the light emitting sources comprises a plurality of light emitting sources associated with the second compartment;
the conductor comprises a plurality of conductors electronically coupling respective first and third electrodes; and
the detector is operable to detect light emitted from each light emitting source in the second compartment.

27. The system of claim 26, wherein the plurality of light emitting sources are light-emitting diodes.

28. The system of claim 26, wherein the second electrode is a cathode and the fourth electrode is an anode.

29. The system of claim 26, wherein the second electrode is an anode and the fourth electrode is a cathode.

30. A system for detecting the presence or amount of an analyte, comprising:
a first compartment;
a first electrode and a first end of a bipolar electrode associated with the first compartment;
a second compartment;
a second electrode and a second end of the bipolar electrode associated with the second compartment;
a first electrolyte solution containing the analyte disposed within the first compartment;
a second electrolyte solution containing an electrochemiluminescent system disposed within the second compartment;
a conductor electronically coupling the first end of the bipolar electrode and the second end of the bipolar electrode;
a voltage source operable to generate a potential difference between the first and second electrodes; and
a detector operable to detect an optical signal generated by the electrochemiluminescent system in the second compartment, thereby detecting the presence or amount of the analyte in the first compartment.

31. The system of claim 30, wherein the first and second compartments share a common barrier, the common barrier comprising an ionically impermeable barrier.

32. The system of claim 31, wherein the first and second ends of the bipolar electrode and the conductor coupling the first and second ends comprise a monolithic bipolar electrode that spans the common barrier.

33. The system of claim 32, further comprising at least two bipolar electrodes spanning the common barrier between said first and second compartments.

34. The system of claim 32, wherein the first region of the bipolar electrode has a larger surface area than the second region.

35. The system of claim 32, further comprising:
a plurality of first compartments having respective first electrodes associated therewith;
the voltage source operable to generate a potential difference between the respective first electrodes and the second electrode; and
the detector operable to detect the optical signal generated by the electrochemiluminescent system in the second compartment, thereby detecting the presence of the analyte in at least one of the first compartments.

36. The system of claim 35, wherein the voltage source is operable to generate the potential difference in a sequential series of the first compartments.

37. The system of claim 35, wherein the voltage source is operable to generate the potential differences simultaneously.

38. The system of claim 30, comprising:
a plurality of first compartments;
respective first electrodes and respective first ends of the bipolar electrode associated with the first compartments;
a switch operable to electronically couple the conductor between one of the respective first ends of the bipolar electrode and the second end of the bipolar electrode;
the voltage source operable to generate a potential difference between the respective first electrodes and the second electrode; and
the detector operable to detect the optical signal generated by the electrochemiluminescent system in the second compartment, thereby detecting the presence of the analyte in one of the first compartments.

39. The system of claim 30, wherein the first electrode and first end of the bipolar electrode are plane parallel and have a separation gap of less than 15 um.

40. A system for detecting the presence or amount of an analyte, comprising:
means for coupling a first electrolyte solution containing the analyte with a first electrode region;
means for coupling a light emitting source with a second electrode region;
means for electronically coupling the first and second electrode regions;
means for generating a potential difference between the first and second electrode regions; and
means for detecting light emitted from the light emitting composition at the second electrode region, thereby indicating the presence or amount of the analyte at the first electrode region.

41. The system of claim 40, further comprising means for ionically coupling the first and second electrolyte solutions.

42. The system of claim 40, further comprising means for ionically isolating the first and second electrolyte solutions.

43. The system of claim 40, wherein the light emitting source is an electrochemiluminescent system.

44. The system of claim 40, wherein the light emitting source is a light-emitting diode.
